(19) United States
(12) Patent Application Publication
(10) Pub. No.: US 2006/0036801 A1
(43) Pub. Date: Feb. 16, 2006

(54) Scalable matrix register file

(76) Inventors: Christpher S. Jones, Portland, OR (US); Gary L. Brown, Aloha, OR (US); Darrell D. Boggs, Aloha, OR (US)

Correspondence Address: RICHARD C. CALDERWOOD, 2775 NW 126TH AVE, PORTLAND, OR, 97229-8381, US

(21) Appl. No.: 10/916,747

(22) Filed: Aug. 11, 2004

(51) Int. Cl. G06F 12/00

(52) U.S. Cl. 711/101

(57) ABSTRACT

A register file in which the physical row/column mapping is decoupled from the logical row/column mapping. The physical register file includes R*C N-bit storage elements arranged in R rows and C columns. Each physical row includes an N-bit bus, a log₂(C)-bit storage element selection line, and a log₂(C)-bit output column selection line. In either a logical row or logical column access, no more than one storage element is selected per physical row and coupled to that row's bus, and each column's vertical bit line is uniquely coupled to one row's bus. The values on the storage element selection lines and on the output column selection lines determines which storage elements are coupled to which vertical bit lines. The width C of the register file, the number of rows R of the register file, and the size N of the fundamental data storage element can be independently changed without affecting the others. The size X of the X*N-bit logical data elements can be changed without changing R, C, N, or the width of the buses. The same addressing logic is used, regardless of data size and regardless of whether the access is logically row-wise or column-wise. Horizontal wire count is minimized by an appropriate logical-to-physical mapping of the storage cells.

### BACKGROUND OF THE INVENTION

1. Technical Field of the Invention

This invention relates generally to register files for storing data in a processor, and more particularly to register files adapted for use in conjunction with matrix arithmetic logic units.

2. Background Art

FIG. 1 illustrates a conventional digital logic system 10 including a register file 12. The register file includes 64 storage locations organized in an 8-by-8 matrix including eight rows A through H and eight columns 7 through 0. Each storage location may be identified by its row and column location, such as storage location A7, storage location F4, and so forth. Each storage location holds one byte of data.

When data are read out of the register file, they are held in a latch before being provided as input to an arithmetic logic unit (ALU). Commonly, a register file has at least two read ports and can simultaneously provide at least two outputs which are used as operand inputs into one or more ALUs. For simplicity, only a single read port is shown. Commonly, the register file has one or more write ports into which the ALU's result is written back to the register file. For simplicity, no write port is shown.

Within a data item stored within a physical row, the most significant byte (MSB) is toward column 7 and the least significant byte (LSB) is toward column 0, in a “big-endian” configuration. Both the prior art and the present invention will be discussed in terms of big-endian configurations, although neither is thus limited.

Although the storage locations have a “physical” size, such as one byte each, most digital logic systems include hardware for enabling the software to utilize data items of one or more different “logical” sizes. For purposes of illustration, the prior art and the present invention will be explained as being able to access logical data including single-byte data, word (2-byte) data, double-word (4-byte) data, and quad-word (8-byte) data.

Some digital processing systems access and process vectors of these data types, in which two or more data items (of a particular size) are grouped and processed together. Some digital processing systems access and process scalar data (single data items of a particular size). Both types of systems can benefit from improved register file access performance, and from improved register file wiring and configuration.

A word data item occupying e.g. storage locations C7 and C6 is referred to as C7:6, a double-word item occupying storage locations A3, A2, A1, and A0 is referred to as A3:0, and a quad-word item occupying storage locations G7, G6, . . . G0 is referred to as G7:0.

Previously, the register file configuration as it appears to software, known as the “logical” configuration, has been identical with the way that the register file is actually constructed, known as the “physical” configuration. If the logical configuration is an 8-by-8 matrix of single-byte storage locations, then the register file has been physically constructed as an 8-by-8 matrix of single-byte storage locations.

This is not a problem when the register file is being accessed row-wise, because each of the storage elements' data can be directly, vertically driven onto its own, local set of bit lines. However, when the register file is accessed column-wise, the storage elements' data must be driven both vertically and horizontally (so data from multiple data elements in a single column can be driven onto different vertical bit lines). This requires a substantial amount of additional, horizontal wiring and control logic in each row of the register file. Existing systems limit the vector element size that can be accessed column-wise, to avoid an explosion in the number and complexity of required wires and logic.

One example of a recent attempt to deal with this problem is presented in a paper entitled “A Register File with Transposed Access Mode” by Yoochang Jung, Stefan G. Berg, Donglok Kim, and Yongmin Kim of the Image Computing Systems Laboratory at the University of Washington, Seattle, Wash., 98195. Although it does permit both row-wise and column-wise accesses, the Jung register file has several significant drawbacks. It requires separate address decoders for row-wise access and for column-wise access. For each data element size (byte, word, etc.) it requires a separate copy of each of the row-wise and column-wise address decoders. The number of rows useable in column-wise access is reduced by a factor of X, where X is the number of bytes in the data element size. And, as nearly as we can ascertain, the width of each row's bus is equal to the largest permissible data element size.

FIG. 2 illustrates that when the digital logic system makes a vector access of Logical Row A with byte-sized data elements, physical locations A7 through A0 are accessed. When the digital logic system makes a similar vector access of Logical Row B, physical locations B7 through B0 are accessed; a similar vector access of Logical Row C accesses physical locations C7 through C0; and so forth.

FIG. 3 illustrates that when the digital logic system makes a vector access of Logical Row A with word-sized data elements, physical locations A7:6 through A1:0 are accessed. When the digital logic system makes a similar vector access of Logical Row B, physical locations B7:6 through B1:0 are accessed; and so forth.

FIG. 4 illustrates that when the digital logic system makes a vector access of Logical Row A with double-word-sized data elements, physical locations A7:4 and A3:0 are accessed. When the digital logic system makes a similar vector access of Logical Row B, physical locations B7:4 and B3:0 are accessed; and so forth.

FIG. 5 illustrates that when the digital logic system makes a vector (or scalar) access of Logical Row A with quad-word-sized data elements, physical locations A7:0 are accessed. When the digital logic system makes a similar access of Logical Row B, physical locations B7:0 are accessed; and so forth.

FIG. 6 illustrates that when the digital logic system makes a vector access of Logical Column 7 with byte-sized data elements, physical locations A7 through H7 are accessed. When the digital logic system makes a similar access of Logical Column 6, physical locations A6 through H6 are accessed; and so forth.

Thus, for all row-wise accesses and for byte-sized column-wise access, the existing systems do just fine. The problem manifests itself when word-sized and larger column-wise accesses are performed.

FIG. 7 illustrates that when the digital logic system makes a vector access of Logical Column 7 with word-sized data elements, physical locations A7:6 through D7:6 are accessed. When the digital logic system makes a similar access of Logical Column 6, physical locations A5:4 through D5:4 are accessed; Logical Column 5 accesses physical locations A3:2 through D3:2; Logical Column 4 accesses physical locations A1:0 through D1:0; Logical Column 3 accesses physical locations E7:6 through H7:6; and so forth.

FIG. 8 illustrates that when the digital logic system makes a vector access of Logical Column 7 with double-word-sized data elements, physical locations A7:4 and B7:4 are accessed. When the digital logic system makes a similar access of Logical Column 6, physical locations A3:0 and B3:0 are accessed; Logical Column 5 accesses physical locations C7:4 and D7:4; and so forth.

FIG. 9 illustrates that when the digital logic system makes a vector (or scalar) access of Logical Column 7 with quad-word-sized data elements, physical locations A7:0 are accessed. When the digital logic system makes a similar access of Logical Column 6, physical locations B7:0 are accessed, and so forth. (In the degenerate case when the data size matches the number of physical storage locations in a row and column, row-wise and column-wise accesses to the same index will access the same storage locations.)

Referring to FIG. 1 and FIGS. 2-5, it can be seen that row-wise access does not cause any read port or bit line problems, because each byte of each data item comes out on its own, unique set of bit lines from the register file to the latch.

However, referring to FIG. 1 and FIGS. 6-9, it can be seen that column-wise access of any size of data item smaller than the full register file width creates a problem of routing the accessed data horizontally to the appropriate bit lines. For example, in FIG. 8, bytes A7 and B7 are stored in physical storage locations which are both in the same physical column; somehow, the data from B7 must be steered to the bit lines that are associated with column 6 not column 7.

Some existing systems have solved this problem by adding additional decoders which require vertical column select lines and additional horizontal routing associated with each data port and for each data size which the system is able to access. For example, to perform the read shown in FIG. 6, a decoder at the top of the register file causes a column select line to enable bytes A7 through H7 to be driven horizontally along 8-bit-wide buses. Additional switching logic then connects the horizontal data with the vertical bit lines to allow the desired data to be available in the proper output position. To perform the read shown in FIG. 7, data must be driven horizontally along 16-bit-wide buses. And to perform the read shown in FIG. 8, data must be driven horizontally along 32-bit-wide buses. One fundamental problem with this existing approach is that the buses must be as large as the largest vector element size which causes two or more bytes to be selected within any given column.

What is needed, then, is an improved matrix register file which, with a minimal amount of additional wiring, allows logical rows and columns to be accessed using any of several elemental data sizes.

### BRIEF DESCRIPTION OF THE DRAWINGS

FIG. 1 shows a register file and arithmetic logic unit according to the prior art.

FIGS. 2-5 show a conventional register file, highlighting storage locations which are accessed when performing reads of eight bytes, four words, two double-words, and one quad-word, respectively, from a row.

FIGS. 6-9 show a conventional register file, highlighting storage locations which are accessed when performing reads of eight bytes, four words, two double-words, and one quad-word, respectively, from a column.

FIG. 10 shows a digital logic system according to one embodiment of this invention.

FIG. 11 shows one embodiment of register file control logic such as may be employed in the system of FIG. 10.

FIGS. 12L and 12P show the register file of this invention, in its logical and physical organization, respectively, highlighting storage locations which are accessed when performing a read of eight bytes from a row.

FIGS. 13L and 13P show the register file of this invention, in its logical and physical organization, respectively, highlighting storage locations which are accessed when performing a read of four words from a row.

FIGS. 14L and 14P show the register file of this invention, in its logical and physical organization, respectively, highlighting storage locations which are accessed when performing a read of two double-words from a row.

FIGS. 15L and 15P show the register file of this invention, in its logical and physical organization, respectively, highlighting storage locations which are accessed when performing a read of one quad-word from a row.

FIGS. 16L and 16P show the register file of this invention, in its logical and physical organization, respectively, highlighting storage locations which are accessed when performing a read of eight bytes from a column.

FIGS. 17L and 17P show the register file of this invention, in its logical and physical organization, respectively, highlighting storage locations which are accessed when performing a read of four words from a column.

FIGS. 18L and 18P show the register file of this invention, in its logical and physical organization, respectively, highlighting storage locations which are accessed when performing a read of two double-words from a column.

FIGS. 19L and 19P show the register file of this invention, in its logical and physical organization, respectively, highlighting storage locations which are accessed when performing a read of one quad-word from a column.

FIGS. 20A-D together show one embodiment of the contents of a lookup table, or of the output of logic, including the element selection line values and column output selection line values which result from each address combination of row-wise indicator, row/column index, and data element size indicator.

FIG. 21 shows a register file with the lookup table which controls access to the register file's storage locations.

FIGS. 22L and 22P show another embodiment of a register file mapping and an access of a logical row of words.

FIGS. 23L and 23P show the register file mapping of FIG. 22 and an access of a logical column of words.

FIG. 24 shows another embodiment of a register file system according to this invention, in which only a portion of the register file uses the mapping feature of this invention and the remainder uses a conventional mapping.

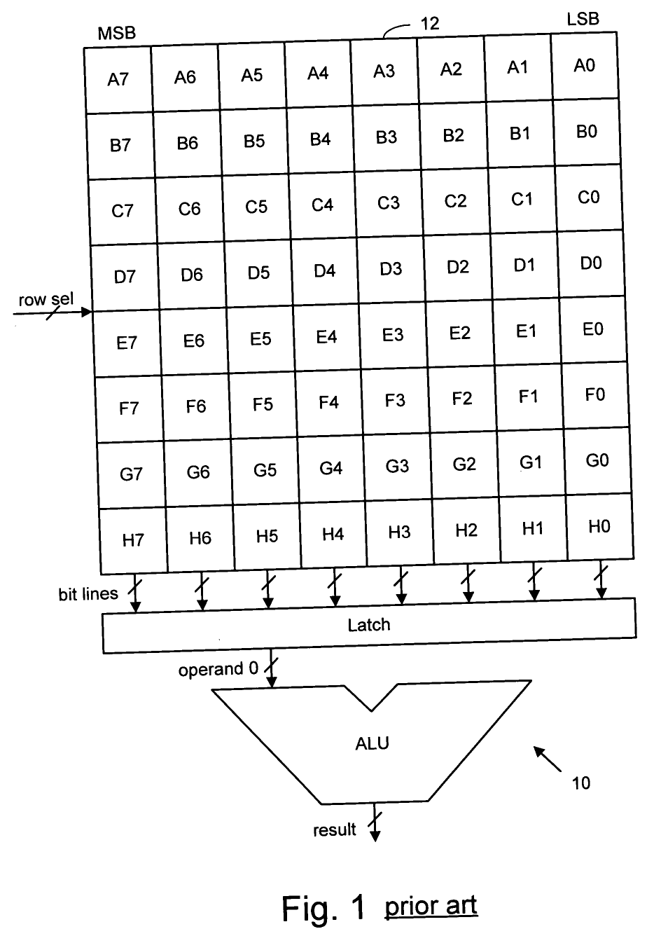

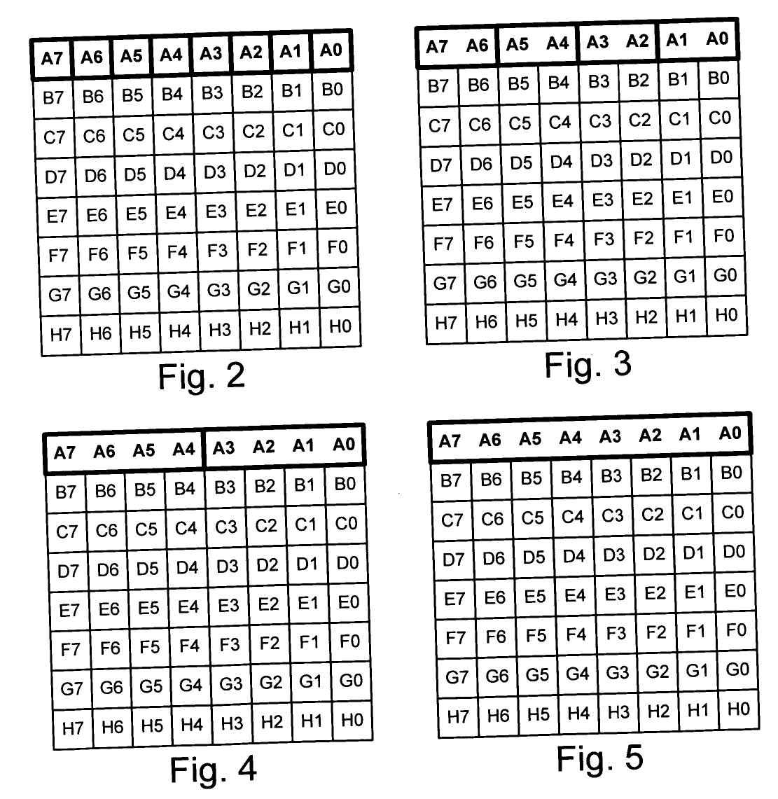

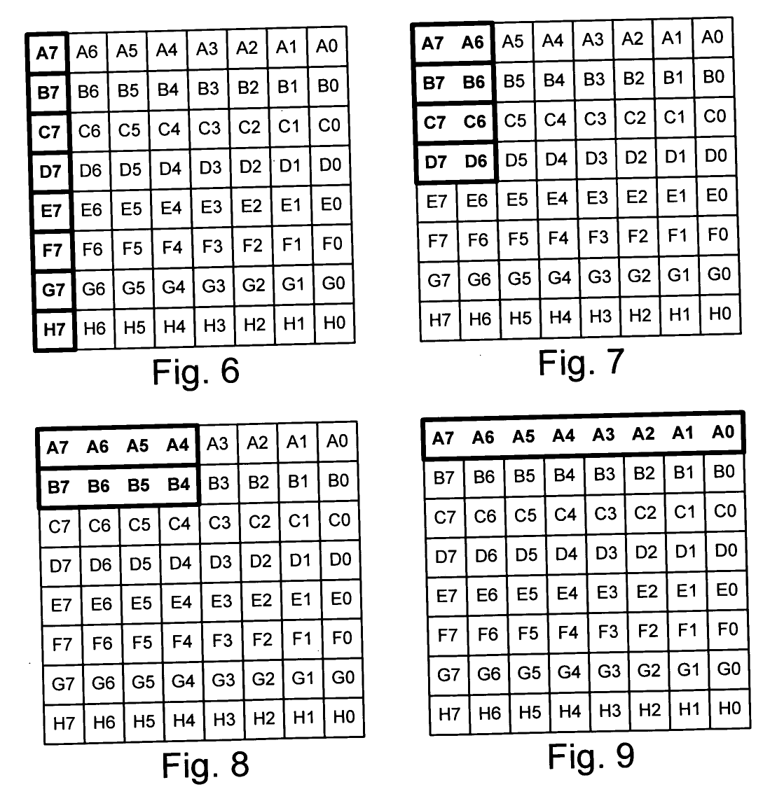

### DETAILED DESCRIPTION

The invention will be understood more fully from the detailed description given below and from the accompanying drawings of embodiments of the invention which, however, should not be taken to limit the invention to the specific embodiments described, but are for explanation and understanding only.

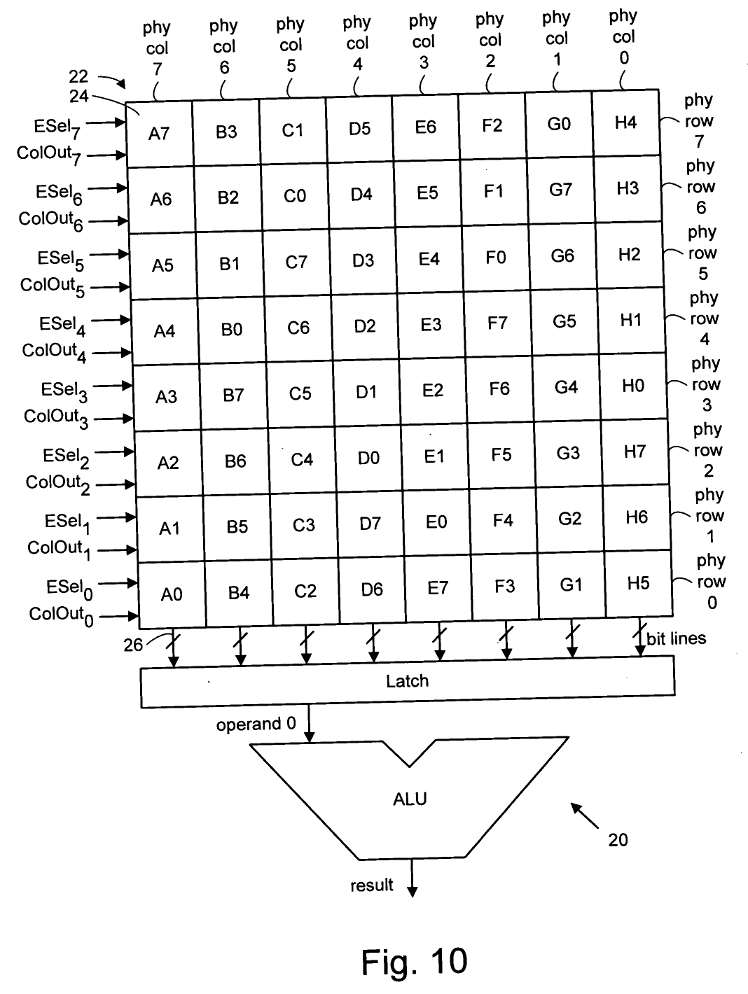

FIG. 10 illustrates one embodiment of an improved matrix register file system 20 according to this invention. Again, for simplicity, only a single read port is shown. The improvement in the register file includes both a reorganization of the logical-to-physical location mapping within any particular column, and a change in how the physical storage locations are accessed. The register file includes physical columns 7 through 0 shown organized left to right and storing Logical Rows A through H, respectively. The register file includes physical rows 7 through 0 shown organized top to bottom.

In the prior art, logical rows and physical rows were the same thing. In the prior art, logical columns and physical columns were the same thing. In other words, a storage location's logical address e.g. “D4” precisely indicated its physical location within the register file. Row-wise access was performed simply by decoding the register address and activating a single “row select” line.

According to the present invention, logical rows are organized in physical columns, and within each physical column, the storage locations have been reordered differently. The result is that logical rows and physical rows are not only not the same thing, but the physical locations that make up a logical row are not even stored in the same physical row.

This reorganization can be done in a variety of manners. FIG. 10 illustrates but one example. Logical Row A is stored in the physical column 7, Logical Row B is stored in physical column 6, and so forth.

Within physical column 7, the storage locations of Logical Row A are stored sequentially from physical row 7 to physical row 0. Within physical column 6, the storage locations of Logical Row B are stored sequentially from physical row 3 to physical row 0, wrapping to physical row 7 and continuing to physical row 4. Within physical column 5, the storage locations of Logical Row C are stored sequentially from physical row 5 to physical row 0, wrapping to physical row 7 and continuing to physical row 6. Within physical column 4, the storage locations of Logical Row D are stored sequentially from physical row 1 to physical row 0, wrapping to physical row 7 and continuing to physical row 2. Within physical column 3, the storage locations of Logical Row E are stored sequentially from physical row 0, wrapping to physical row 7 and continuing to physical row 1. Within physical column 2, the storage locations of Logical Row F are stored sequentially from physical row 4 to physical row 0, wrapping to physical row 7 and continuing to physical row 5. Within physical column 1, the storage locations of Logical Row G are stored sequentially from physical row 6 to physical row 0, wrapping to physical row 7. Within physical column 0, the storage locations of Logical Row H are stored sequentially from physical row 2 to physical row 0, wrapping to physical row 7 and continuing to physical row 3.

No two Logical Rows have their storage starting in the same physical row, and, significantly, the physical storage locations which are accessed in any single logical column-wise access of any data size are all stored within different physical rows. Each physical row contains exactly one element from each logical row.

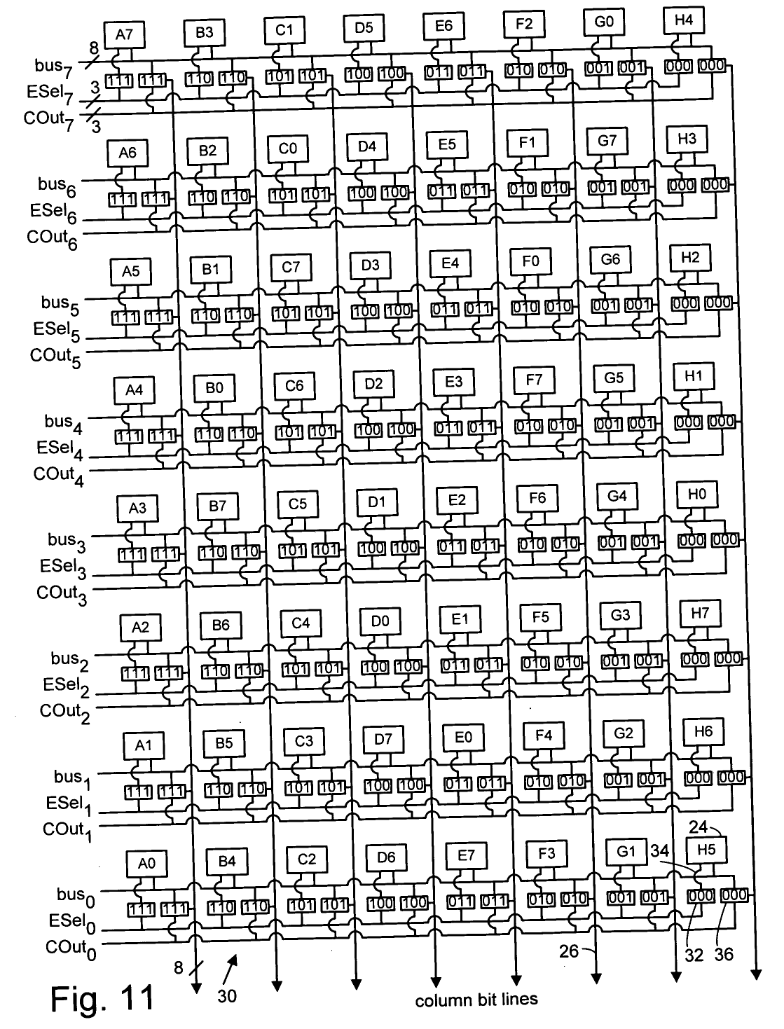

FIG. 11 illustrates one embodiment of a register file 30 such as may be used in the system of FIG. 10, and includes an illustration of the register file storage locations. Rather than the entire register file being provided with a single, simple “row select” line as in the prior art, in the present invention each physical row is provided with a pair of dedicated controls. A multi-bit entry select line ESel_{N} selects one physical storage location 24 from the physical row; in the example shown, a given three-bit ESel_{N} line selects one of the eight storage locations in an associated row. A multi-bit column output selector line COut_{N} line selects a vertical bit line on which the selected storage location's data will be read out from the register file. Thus, the physical column position of the storage element does not dictate the register file output column position at which the storage element's data will be output. If physical row 7 is accessed with an ESel₇ value of 3 (binary 011) and a COut₇ value of 6 (binary 110), the contents of logical storage location E6 will be provided at physical column 6. If there are 2^{N} physical columns, there will be N bits in the ESel line and N bits in the COut line.

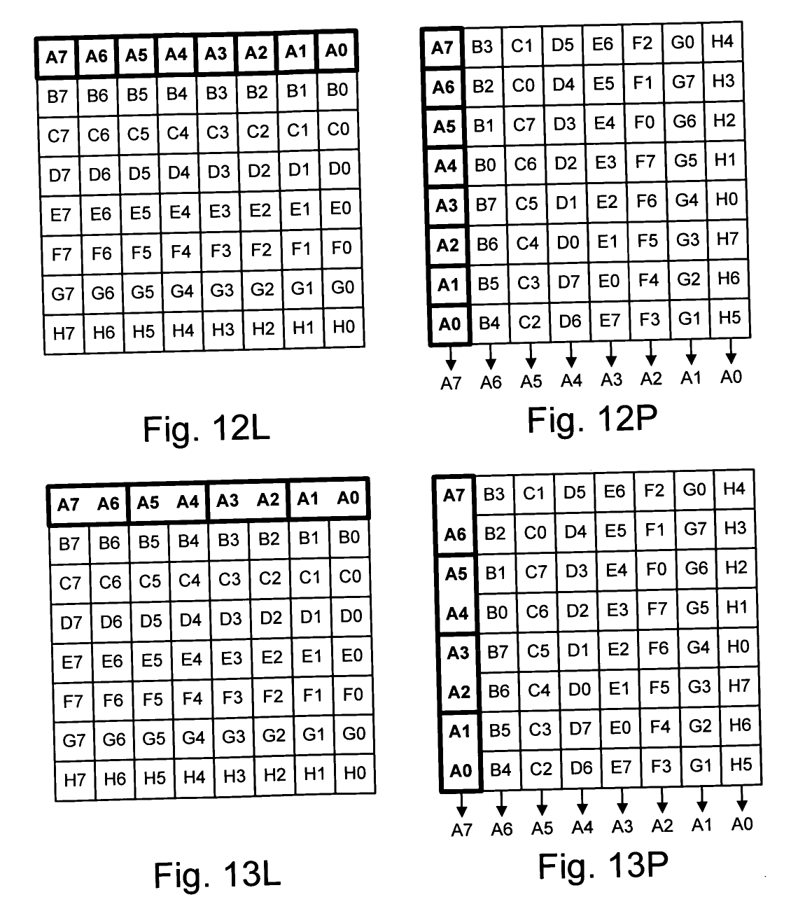

Each storage location has a dedicated selection logic element 32 and a dedicated column output control logic element 36. In one embodiment, the selection logic element is a three-input AND gate with its inputs in positive or negative (inverted) state as indicated by the three-digit binary value, such that if that three-digit value is asserted on the ESel line, exactly that one selection logic element in the physical row will produce an active output enable signal to its storage cell. In the illustrated embodiment, the storage cell responds to this enable signal by outputting its stored value onto a common bus_{N} which is shared by the storage elements in that physical row. In one embodiment, the output control logic element operates similarly, such that if its corresponding three-digit value is asserted on the COut line, exactly that one output control element will pass onto its corresponding eight-bit column output bit line 26 the value on the bus. FIG. 12L illustrates a row-wise access of single-byte data, showing the register file in its logical organization. FIG. 13P illustrates the corresponding access of the physical register file of FIG. 10. The eight individual single-byte data items of Logical Row A are organized in physical column 7. The eight ESel and COut values generated for this access are:

| | | | |
|---|---|---|---|
| ESel₇ | 111 | COut₇ | 111 |
| ESel₆ | 111 | COut₆ | 110 |
| ESel₅ | 111 | COut₅ | 101 |
| ESel₄ | 111 | COut₄ | 100 |
| ESel₃ | 111 | COut₃ | 011 |
| ESel₂ | 111 | COut₂ | 010 |
| ESel₁ | 111 | COut₁ | 001 |
| ESel₀ | 111 | COut₀ | 000 |

FIG. 12P illustrates the logical storage locations which are output at each of the physical columns—A7 through A0.

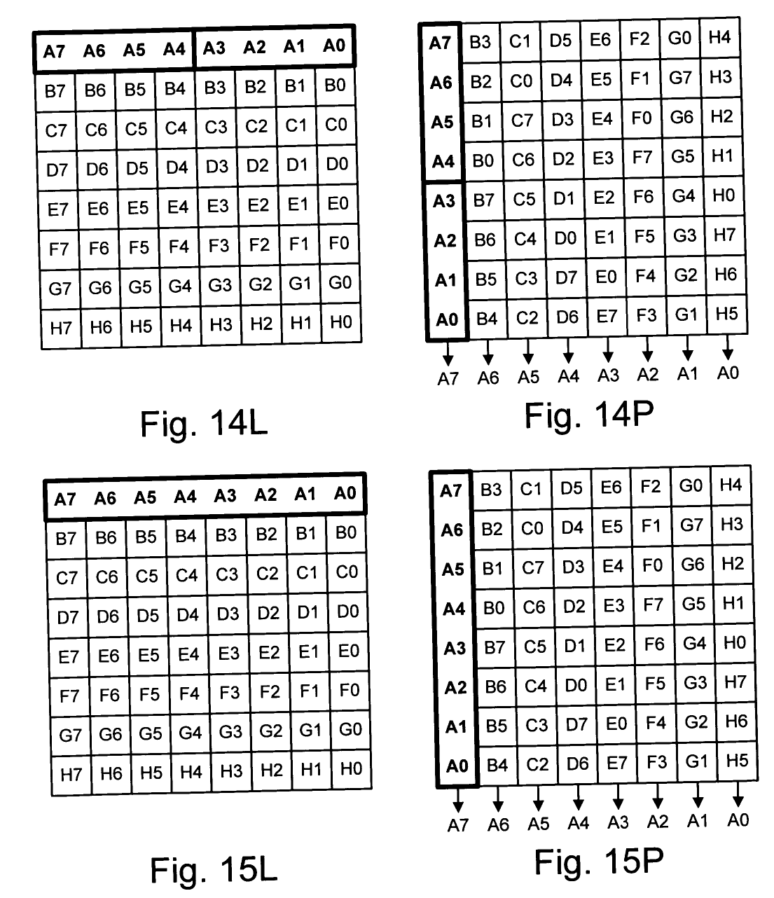

FIGS. 13L and 13P, 14L and 14P, and 15L and 15P illustrate row-wise access of word, double-word, and quad-word data, respectively. In each case, the ESel and COut values are the same as given above regarding FIG. 11.

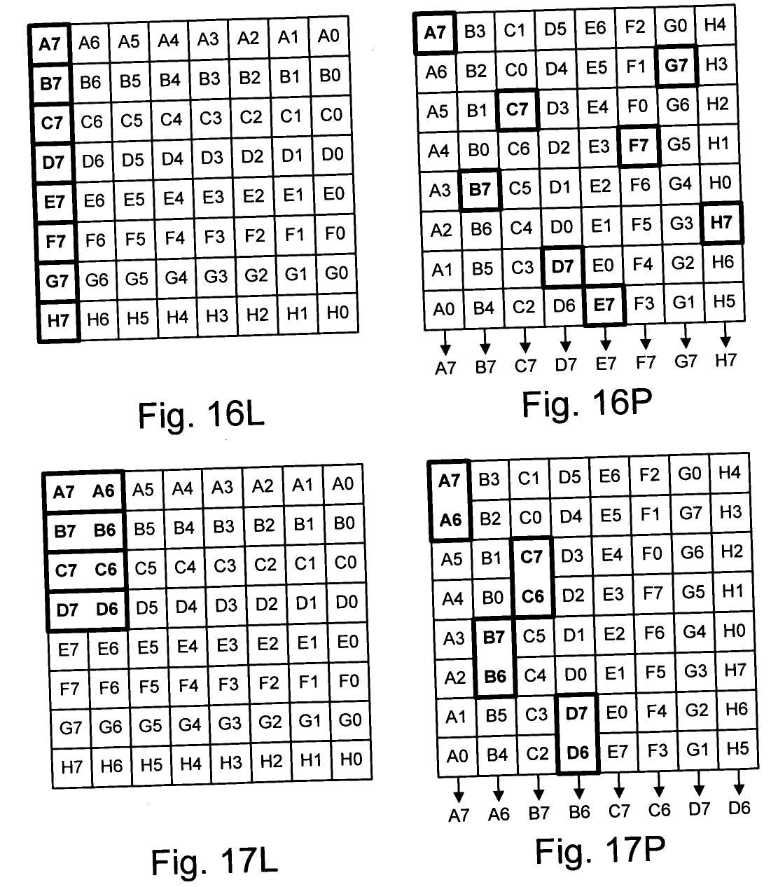

FIGS. 16L and 16P illustrate logical and physical column-wise access of byte data from Logical Column 7. Logical Column 7 includes byte data at logical locations A7, B7, C7, D7, E7, F7, G7, and H7. As can be seen in FIG. 16P, no two of these are in the same physical row. The ESel and COut values generated for this access are:

| | | | |
|---|---|---|---|
| ESel₇ | 111 | COut₇ | 111 |
| ESel₆ | 001 | COut₆ | 001 |
| ESel₅ | 101 | COut₅ | 101 |
| ESel₄ | 010 | COut₄ | 010 |
| ESel₃ | 110 | COut₃ | 110 |
| ESel₂ | 000 | COut₂ | 000 |
| ESel₁ | 100 | COut₁ | 100 |
| ESel₀ | 011 | COut₀ | 011 |

FIGS. 17L and 17P illustrate logical and physical column-wise access of word data from Logical Column 7, which includes word data at logical locations A7:6, B7:6, C7:6, and D7:6. As can be seen in FIG. 17P, no two bytes of these logical locations are stored in the same physical row. The ESel and COut values generated for this access are:

| | | | |
|---|---|---|---|
| ESel₇ | 111 | COut₇ | 111 |
| ESel₆ | 111 | COut₆ | 110 |
| ESel₅ | 101 | COut₅ | 011 |
| ESel₄ | 101 | COut₄ | 010 |
| ESel₃ | 110 | COut₃ | 101 |
| ESel₂ | 110 | COut₂ | 100 |
| ESel₁ | 100 | COut₁ | 001 |
| ESel₀ | 100 | COut₀ | 000 |

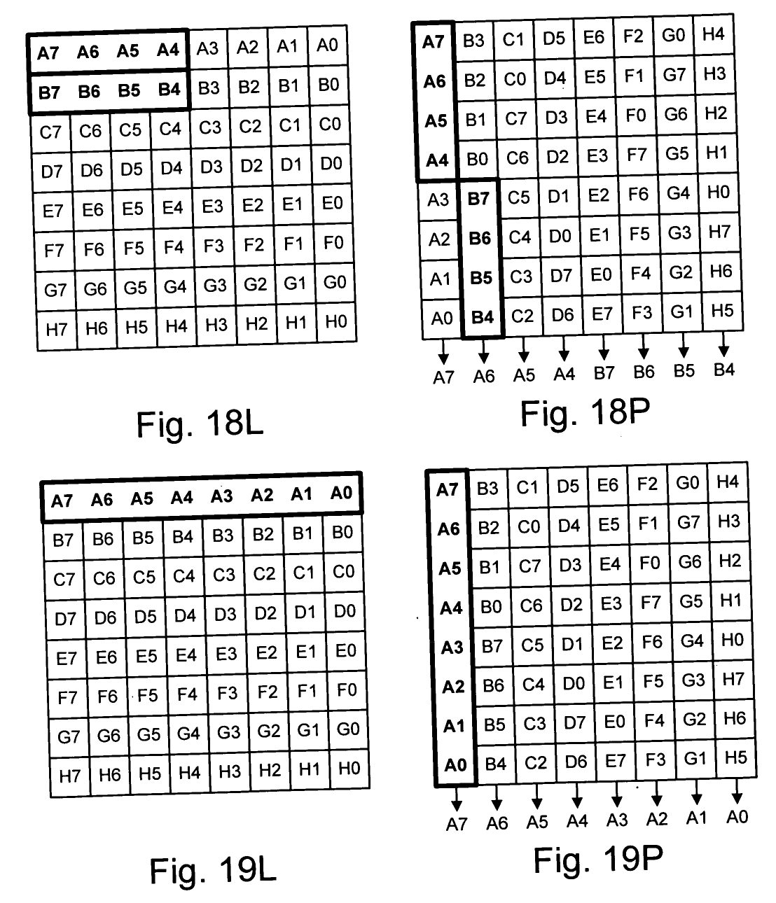

FIGS. 18L and 18P illustrate logical and physical column-wise access of double-word data from Logical Column 7, which includes double-word data at logical locations A7:4 and B7:4. As can be seen in FIG. 18P, no two bytes of these logical locations are stored in the same physical row. The ESel and COut values generated for this access are:

| | | | |
|---|---|---|---|
| ESel₇ | 111 | COut₇ | 111 |
| ESel₆ | 111 | COut₆ | 110 |
| ESel₅ | 111 | COut₅ | 101 |
| ESel₄ | 111 | COut₄ | 100 |
| ESel₃ | 110 | COut₃ | 011 |
| ESel₂ | 110 | COut₂ | 010 |
| ESel₁ | 110 | COut₁ | 001 |
| ESel₀ | 110 | COut₀ | 000 |

FIGS. 19L and 19P illustrate logical and physical column-wise access of quad-word data from Logical Column 7, which includes quad-word data at logical locations A7:0. As can be seen in FIG. 19P, no two bytes of these logical locations are stored in the same physical row. The ESel and COut values generated for this access are:

| | | | |
|---|---|---|---|
| ESel₇ | 111 | COut₇ | 111 |
| ESel₆ | 111 | COut₆ | 110 |
| ESel₅ | 111 | COut₅ | 101 |
| ESel₄ | 111 | COut₄ | 100 |
| ESel₃ | 111 | COut₃ | 001 |
| ESel₂ | 111 | COut₂ | 000 |
| ESel₁ | 111 | COut₁ | 001 |
| ESel₀ | 111 | COut₀ | 000 |

The ESel and COut values are, in one embodiment, driven from a lookup table. The lookup table is indexed by the logical row or logical column identifier, a data size indicator, and a column-wise/row-wise selector value.

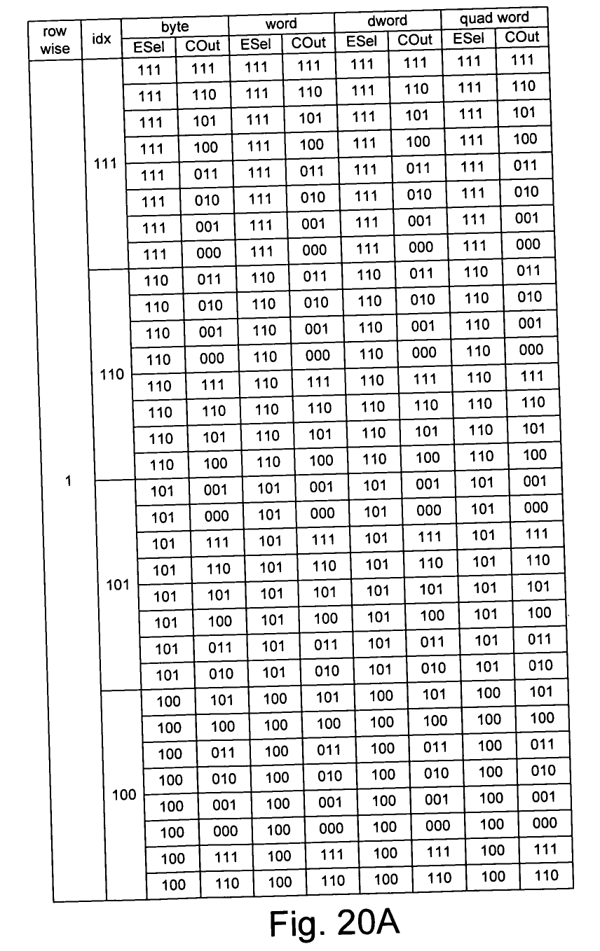

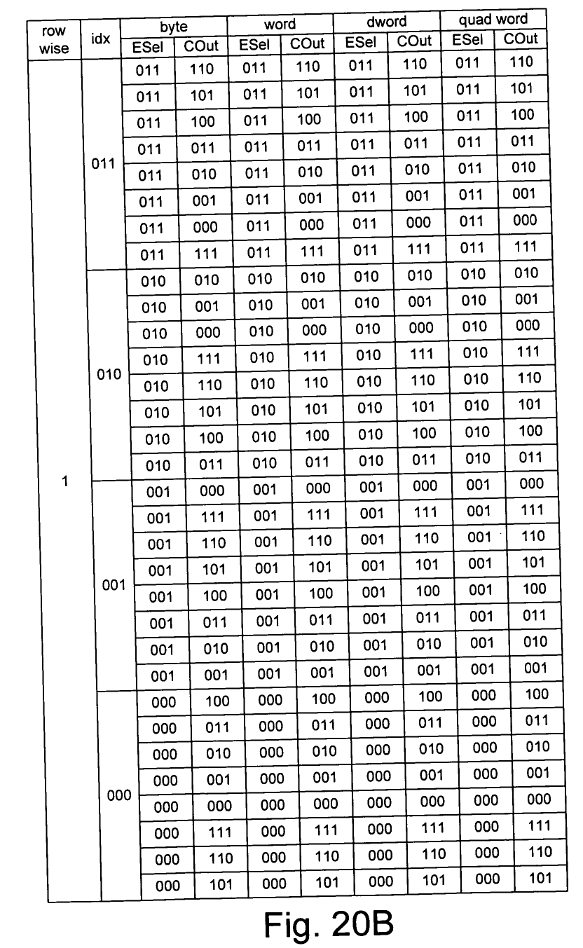

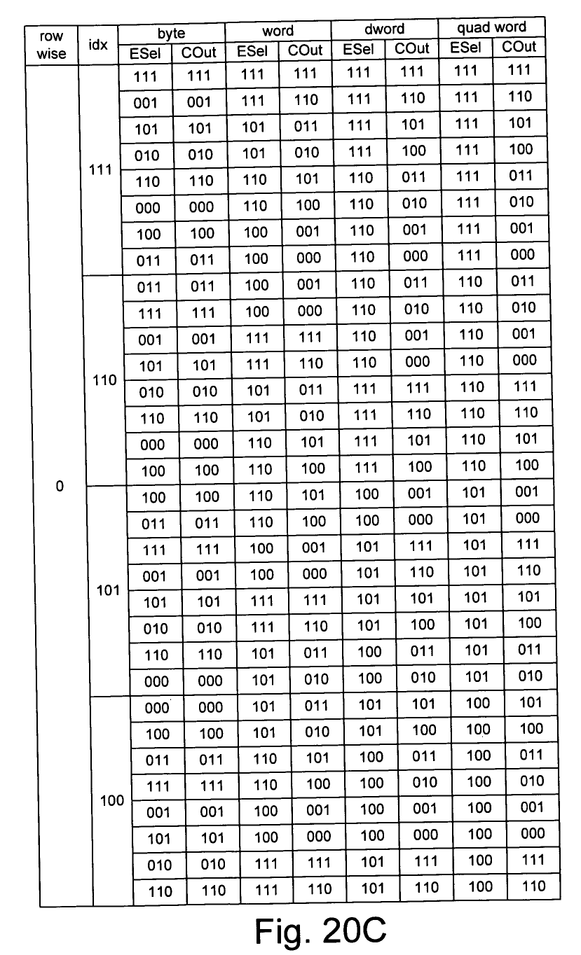

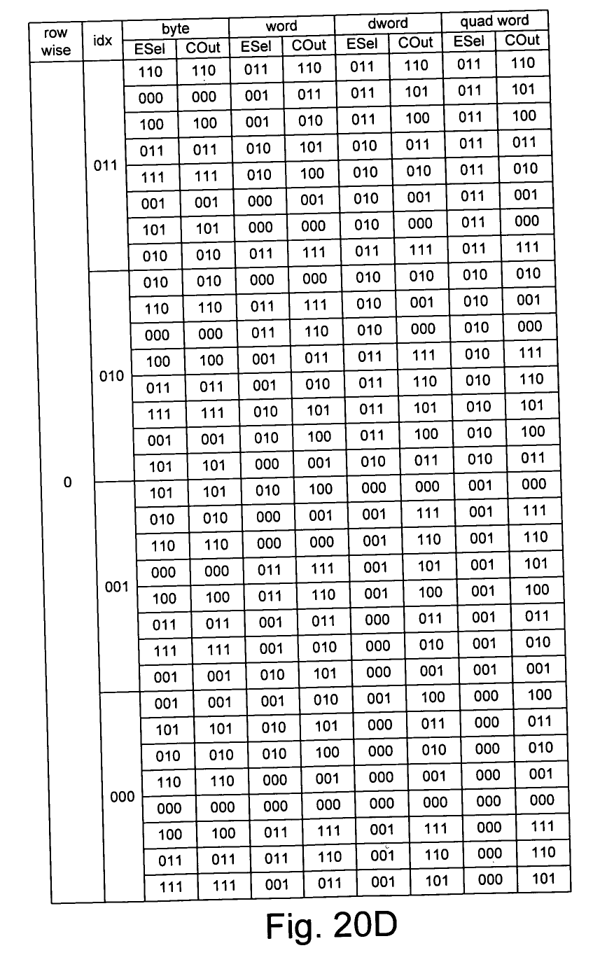

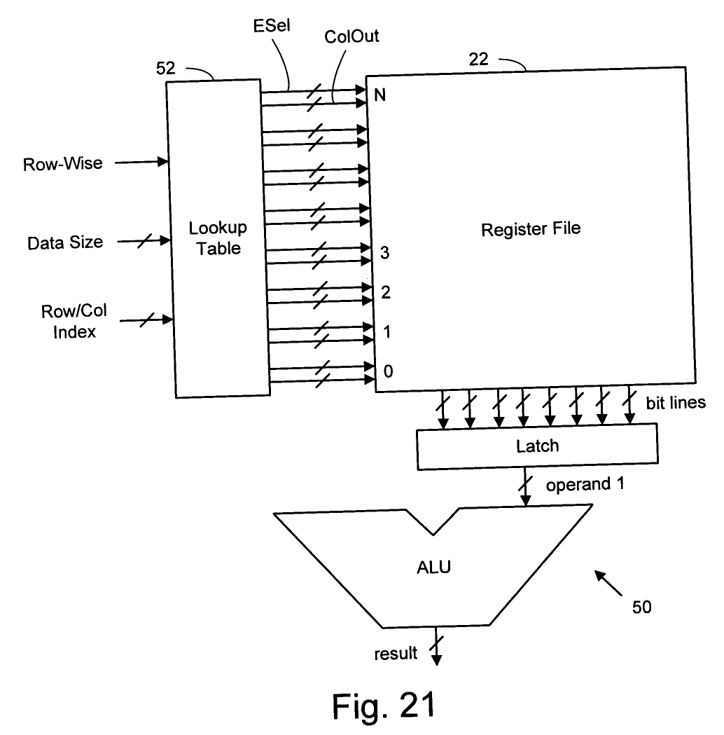

FIGS. 20A-D together illustrate one example of a suitable lookup table for generating the ESel and COut values. For ease of understanding, the respective byte, word, double-word, and quad-word sections have been grouped vertically; however, the two-bit value which selects between these four addressing modes might typically be utilized in conjunction with the row-wise selector bit and the three-bit row or column selector value. In other words, the lookup table may be indexed by a 6-bit value comprising:
<1-bit row-wise indicator><3-bit row or column index><2-bit size indicator>

If the row-wise indicator value is 1, the register file is being accessed row-wise; if it is 0, the register file is being accessed column-wise. The row or column index is a value in the range 111 (7) through 000 (0). A size indicator of 00 may cause byte-sized data access, 01 may cause word-sized data access, 10 may cause double-word-sized data access, and 11 may cause quad-word-sized data access. If other sizes are permitted, the indicator will need to be encoded accordingly. Similarly, the size of the row or column index will need to be selected according to the size of the register file.

Typically, the table will output forty-eight bits, comprised of the three-bit ESel value and the three-bit COut value for each of the eight physical rows in the register file. Within each cell of the following table, the eight three-bit values are organized top to bottom indicating the ESel or COut values provided to physical row 7 through physical row 0. The number of bits output per table access will depend on the size of the register file.

In other embodiments, rather than the ESel and COut values being stored in a table, they could be generated by decoder logic. This may offer some opportunity for die area savings. For example, in row-wise access mode, the ESel value is simply the same as the row/column index value, which can be passed straight through the decoder logic without the need for any storage cells. Similarly, in bite-size column-wise access mode, the ESel and COut values are identical, and in quad-word column-wise access mode, the ESel value is the same as the row/column index value. These and other embodiments and optimizations will be readily apparent to those skilled in the art, armed with the teachings of this disclosure.

FIG. 21 illustrates the register matrix system 50 including the improved register file 22 of FIG. 10, and a lookup table 52 such as that given above.

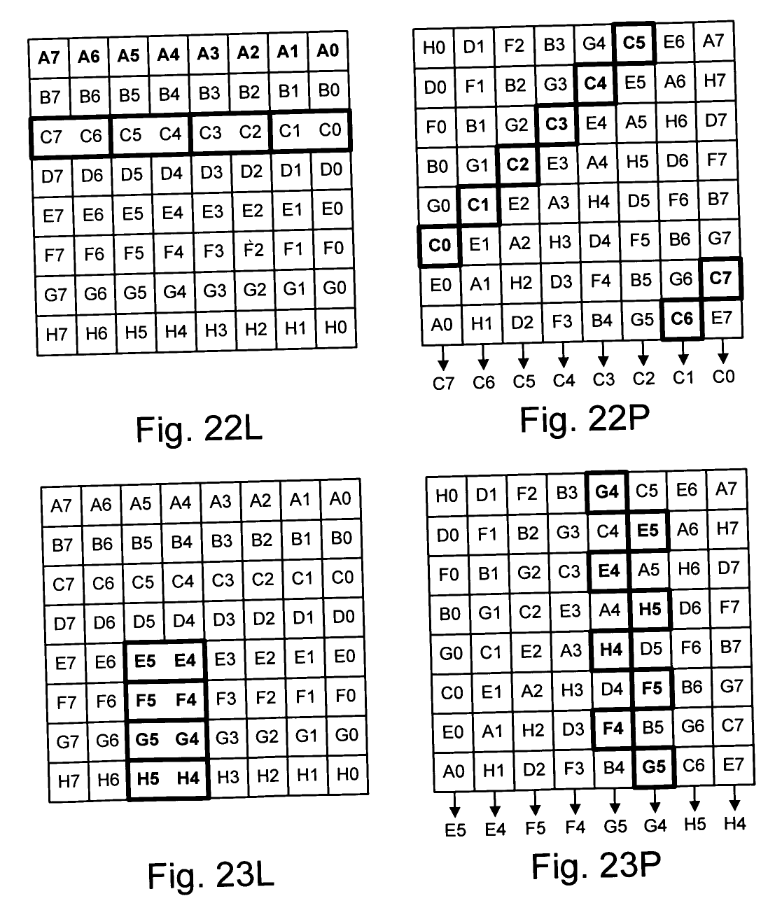

FIGS. 22L and 22P illustrate one alternative logical-to-physical mapping of a register file according to another embodiment of this invention, in which corresponding bytes of the respective logical rows are organized into the same physical column (whereas, in FIGS. 13L and 13P, for example, each physical column contained a single logical row). A word-size access of Logical Row C results in an access of one byte per physical row. The COut logic (not shown) moves the respective bytes onto their respective appropriate column bit lines.

FIGS. 23L and 23P illustrate the alternatively mapped register file performing a word-size access of Logical Column 2 (bytes 5-4 of Logical Rows E-H), which again results in one byte per physical row being accessed and moved onto appropriate column bit lines.

There are a variety of such mappings which can be applied to the physical register file within the teachings of this invention. What matters is that, regardless of which logical row or column and which data element size is used in the access, no physical row contains two or more of the required storage locations.

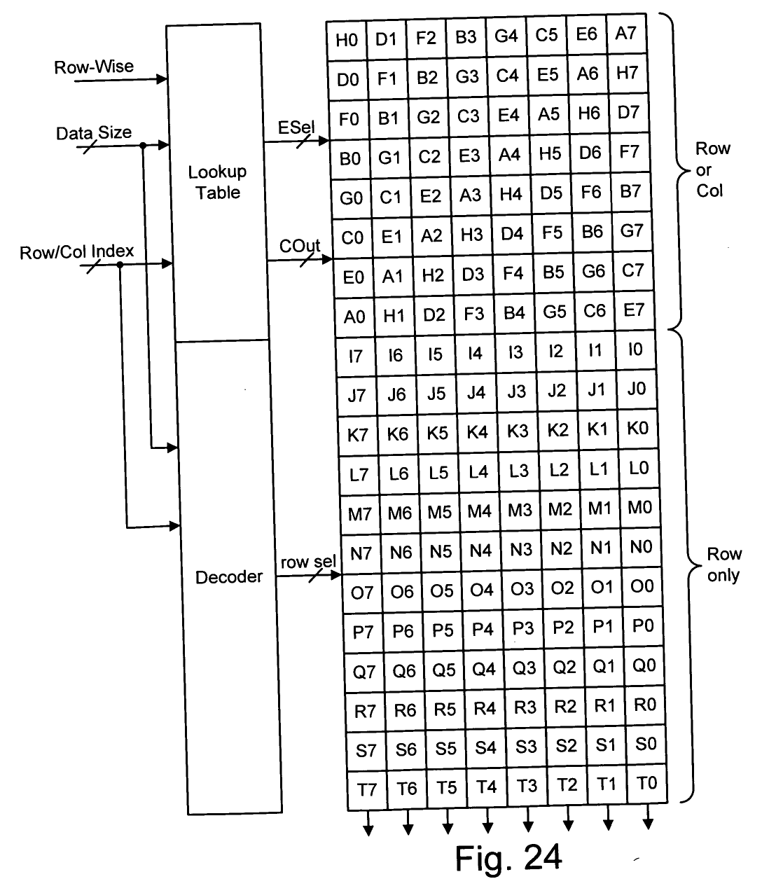

FIG. 24 illustrates another embodiment of a register file system utilizing the principles of this invention in only a first (upper) portion of its register file. The remaining (lower) portion of the register file uses a conventional addressing or mapping scheme.

When the digital logic system (not shown) makes an access of a logical row or column whose address puts it within the first portion of the register file, the lookup table (or other suitable means such as a state machine or hard coded logic) uses the row-wise indicator, data size indicator, and row/column index to generate the appropriate ESel and COut values to access the required storage elements within the first portion of the register file. The ESel values select the correct storage element in each respective row of that portion of the register file, and the COut values steer them onto their correct bit lines. The first portion of the register file thus permits accessing both logical rows and logical columns.

When the digital logic system makes an access of a logical row whose address puts it within the second portion of the register file, e.g. if the first portion contains 16 logical rows 0 through 15 and the access is to logical row 27, decoder logic responds to the logical row index to generate a row select signal enabling access of a physical row within the second portion of the register file. Because the second portion does not use the COut logic, the bytes within the selected row cannot be steered and are simply output on the bit lines at their respective column positions. Thus, the second portion of the register file permits accessing only logical rows. The COut lines in the first portion of the register file are enhanced with an extra “enable” bit which, when deasserted, prevents that that row from being coupled to any of the bit lines. Alternatively, a single enable line could be added to decouple the first portion's bit lines from the second portion's bit lines.

In other embodiments, the second portion of the register file could be modified to permit accessing logical columns as well. In one such embodiment, the technique of this invention could be used. In other embodiments, other techniques could be used.

In one embodiment, two or more register files according to the teachings of this invention may be stacked vertically, to share bit lines. For example, if the physical row is 8 bytes wide, it may be convenient to include 8 physical rows in the register file so it is square. Then, if more than 8 rows are needed, it may be convenient to simply stack two such register files vertically, and use the most significant bit of the row/column index value to select between the two register files.

### Conclusion

When one component is said to be “adjacent” to another component, it should not be interpreted to mean that there is absolutely nothing between the two components, only that they are in the order indicated.

The various features illustrated in the figures may be combined in many ways, and should not be interpreted as though limited to the specific embodiments in which they were explained and shown.

Except where expressly indicated otherwise, the term “line” should not be interpreted as meaning exactly one single wire; rather, it generally indicates one or more wires carrying one or more related bits of data.

Those skilled in the art having the benefit of this disclosure will appreciate that many other variations from the foregoing description and drawings may be made within the scope of the present invention. Indeed, the invention is not limited to the details described above. Rather, it is the following claims including any amendments thereto that define the scope of the invention.

What is claimed is:

1. A method of operating a register file in response to an access of M X*N-bit data elements in a logical row or logical column of a register file, wherein M, X, and _{N} are positive integers, and wherein the register file includes a plurality of N-bit storage elements arranged in R physical rows and C physical columns, each physical column including an N-bit bit line, the method comprising:
regardless of whether the access is to a logical row or a logical column, accessing no more than 1 N-bit storage element in each of M*X physical rows of the register file; and
coupling each of the M*X storage elements to a respective one of the N-bit bit lines according to a required ordering of the M data elements.

2. The method of claim 1 wherein each physical row of the register file includes a respective N-bit bus, and wherein the access is a read access, and the coupling comprises:
outputting each accessed storage element's data contents onto the bus of that storage element's bus; and
steering data contents from each respective bus onto one column's bit line, according to the required ordering.

3. The method of claim 1 wherein each physical row of the register file includes a respective N-bit bus, and wherein the access is a write access, and the coupling comprises:
steering data contents from each respective column's bit line onto one row's bus; and
writing into each accessed storage element the data contents steered onto the bus of that storage element's row.

4. The method of claim 1 further comprising:
decoding a row/column index of the access to generate, for each of the M*X physical rows,
a log₂(C)-bit ESel value, and
a log₂(C)-bit COut value; and
applying each ESel value to its physical row to select no more than one storage element from that row;
applying each COut value to its physical row to select a unique bit line, whereby the required ordering is achieved.

5. A register file system comprising:
a register file having,
a plurality of N-bit storage elements arranged in R physical rows and C physical columns,
R element selection lines each associated with a respective one of the R physical rows,
R column output control lines each associated with a respective one of the R physical rows,
R N-bit buses each associated with a respective one of the R physical rows, and
C N-bit bit lines each associated with a respective one of the C physical columns; and
digital logic means, responsive to a request for accessing M X*N-bit data elements in either one of a logical row and a logical column, for generating M*X ESel values onto M*X respective element selection lines and M*X unique COut values onto M*X respective column output control lines, whereby exactly one storage element is accessed in each of M*X physical rows of the register file.

6. The register file system of claim 5 wherein:
the digital logic means is further responsive to a data size selection value which is variable to determine X.

7. The register file system of claim 5 wherein:
the register file further has,
Z*R additional such element selection lines,
Z*R additional such column output control lines,
Z*R additional such buses, and
Z*C additional such bit lines; and
the register file system further comprises Z additional such digital logic means;
whereby the register file system is Z+1-ported, wherein Z>=1.

8. The register file system of claim 7 wherein:
at least one of the ports is a read port; and
at least one of the ports is a write port.

9. The register file system of claim 5 wherein the digital logic means comprises:
means for generating the ESel and COut values; and
associated with each row/column position in the register file,
a first log₂(C)-to-1 decoder coupled to that row's element selection line and uniquely responsive within the first decoders of that row to a predetermined ESel value, and
a second log₂(C)-to-1 decoder coupled to that row's column output control line and uniquely responsive within the second decoders of that row to a predetermined COut value.

10. The register file system of claim 9 wherein the means for generating comprises:
a lookup table.

11. The register file system of claim 10 wherein the lookup table is addressed by:
a logical row/column index value; and
a row-wise selector value.

12. The register file system of claim 11 wherein the lookup table is further addressed by:
a data element size selector value which determines X.

13. The register file system of claim 5 wherein:
the register file includes R+Y physical rows and, in each physical row outside the R rows, each storage element is directly coupled to the bit line of its respective column; and
the register file system further comprises addressing means for accessing, in response to an access of a logical row outside the R rows, a plurality of storage elements in a single physical row.

14. A register file comprising:
a plurality of N-bit storage elements arranged in R physical rows and C physical columns;
C N-bit column output lines;
R M-bit element selection lines each coupled to a corresponding physical row of the storage elements;
R M-bit column output selection lines each coupled to a corresponding physical row of the storage elements;
R N-bit buses each coupled to a corresponding physical row of the storage elements;
wherein C=2ˆM;
each storage element having associated therewith a corresponding selection logic element, wherein within any given physical row, the C selection logic elements are uniquely responsive to respective values on that row's selection line to cause their respective storage elements to input/output from/to that row's bus;
each storage element having associated therewith a corresponding column output logic element, wherein within any given physical row, the C column output logic elements are uniquely responsive to respective values on that row's column output selection line to cause the value on that row's bus to be coupled onto their respective column output lines.

15. The register file of claim 14 further comprising:
a lookup table containing element selection line values for driving the R element selection lines and column output values for driving the R column output selection lines.

16. The register file of claim 15 wherein:
the lookup table is addressed by,
a row-wise indicator,
a data size indicator, and
a row/column index.

17. A register file having row-wise and column-wise access capability for accessing logical rows and logical columns of vectors of data items, the register file comprising:
a plurality of N-bit storage elements arranged in an R-by-C matrix including R rows and C columns;
each row including,
an N-bit bus,
a log₂(C)-bit storage element selection line, and
a log₂(C)-bit column output selection line;
each column including,
an N-bit bit line; and
associated with each respective matrix position, in the R-by-C matrix,
a storage selection logic element coupled to the storage element selection line of that matrix position's row and to the storage element, uniquely responsive within that row to a respective predetermined first log₂(C)-bit value on the storage element selection line to couple data from the storage element onto that row's bus, and
a column output selection logic element coupled to the column output selection line of that matrix position's row and to the bus, uniquely responsive within that row to a respective predetermined second log₂(C)-bit value on the column output selection line to couple data from the bus onto that matrix position's bit line.

18. The register file of claim 17 further comprising:
addressing means including,
R ESel outputs coupled to the R storage element selection lines,
R COut outputs coupled to the R column output selection lines,
inputs for decoding a register file address to select data from the storage elements for driving onto the ESel and COut outputs, and
logic means for generating the first and second log₂(C)-bit values.

19. The register file of claim 18 wherein the table inputs comprise:
at least one bit for selecting between row-wise and column-wise access of the register file; and
a plurality of index bits for selecting a row/column from the register file which is to be accessed.

20. The register file of claim 19 wherein the table inputs further comprise:
at least one bit for selecting a data size which is to be accessed in the register file.

21. The register file of claim 20 wherein:
N=8;
R=2ˆM; and
C=2ˆM;
wherein M is an integer at least 2.

22. The register file of claim 21 wherein:
M is an integer at least 3.

23. The register file of claim 22 wherein:
M is an integer at least 4.

24. The register file of claim 18 wherein the logic means comprises:
a lookup table.

25. A register file comprising:
a plurality of N-bit storage elements arranged in a matrix of R horizontal physical rows and C vertical physical columns where N>=8, R>=4, and C>=4;
C vertical N-bit bit lines each associated with a respective one of the physical columns;
R horizontal N-bit buses each associated with a respective one of the physical rows;
R horizontal log₂(C)-bit selection lines each associated with a respective one of the physical rows;
R horizontal log₂(C)-bit output control lines each associated with a respective one of the physical rows;
R*C log₂(C)-bit selection logic elements each associated with a respective one of the storage elements in a given row and given column, and coupled to the selection line of that row to connect that respective storage element to the given row's bus in response to a predetermined log₂(C)-bit selection value being observed on the selection line;
R*C log₂(C)-bit output control logic elements each associated with a respective row and column position in the matrix, and coupled to connect that row's bus to that column's bit line in response to a predetermined log₂(C)-bit output control value being observed on the output control line;
wherein, within any given row, that row's C selection logic elements are respectively responsive to unique log₂(C)-bit selection values, and that row's C output control logic elements are respectively responsive to unique log₂(C)-bit output control values;
whereby the width _{N} of the buses is independent of the number R of rows and of the number C of columns.
